(19) United States
(12) Patent Application Publication
(10) Pub. No.: US 2004/0054991 A1
(43) Pub. Date: Mar. 18, 2004

(54) Debugging tool and method for tracking code execution paths

(76) Inventor: John M. Harres, Thornton, CO (US)

Correspondence Address: HOGAN & HARTSON LLP, ONE TABOR CENTER, SUITE 1500, 1200 SEVENTEEN ST., DENVER, CO, 80202, US

(21) Appl. No.: 10/244,866

(22) Filed: Sep. 17, 2002

(51) Int. Cl. G06F 9/44

(52) U.S. Cl. 717/131

(57) ABSTRACT

A method for determining code execution paths based on stack information provided in a core file. Stack information is processed to determine flow gaps between pairs of functions identified in frames in the stack. Direct call paths are determined between the functions by determining every direct path between the two functions by scanning the source function for called functions and then repeatedly scanning the called functions until a branch reaches the destination function or terminates with a function other than the destination function. In another embodiment, the paths are determined by identifying call branches from the source function and terminating the following of a call branch whenever a repeat function is found. In another embodiment, the result set of potential paths is generated by identifying branches from the source function but only continuing to follow a branch when intermediate functions are followed by a restore function.

### BACKGROUND OF THE INVENTION

1. Field of the Invention

The present invention relates, in general, to programming development and debugging tools, and, more particularly, to software, systems and methods for tracking or determining a code execution path for a program or application, such as an operating system kernel, a user application, and other software programs, generated by a compiler implementing optimization.

2. Relevant Background

Computer system designers and analysts face the ongoing and often difficult task of determining how to fix or improve operation of a computer system that has experienced an unexpected exception or is failing to operate as designed (e.g., is experiencing errors caused by software problems or “bugs”). When a problem or bug in the computer system software is serious enough to stop or interrupt the execution of a running program, this failure is known as a crash. To assist in identifying bugs in the software operating on a computer system, software applications are often configured to write a copy of the memory image of the existing state of the application or kernel at the time of the crash or exception into a file. This memory image file is typically called a core dump or a core file.

The system-level commands or programs in the operating system, i.e., the kernel software, are of particular interest to system analysts in correcting bugs in a crashed computer system. For example, in UNIX®-based systems, the kernel is the program that contains the device drivers, the memory management routines, the scheduler, and system calls. Often, fixing bugs begins with analysis of these executables, which have their state stored in a kernel core file. Similarly, at the user level or in the user space, programs or binaries (e.g., binary, machine readable forms of programs that have been compiled or assembled) can have their state stored in user core files for later use in identifying the bugs causing the user applications to crash or run ineffectively.

In general practice, a panic or other problem occurs in an operating computer system and the system operator transfers the core file or core image of the user program and/or the kernel to a system analyst (such as a third party technical support service) for debugging. However, debugging a program, application, or kernel based solely on the core file can be a very difficult and time-consuming task. One problem faced by system analysts is that it is often impossible to determine the flow of the underlying program, which makes is hard for a debugger to identify the true cause of a panic or other program interruption. Without identifying the true cause of a problem, the debugger may modify a portion of a program that is not “broken” and leave the problematic portion of the program untouched. Hence, there remains a need for an effective method of tracing the path of code execution based on a received core file for a customer computer system.

To better understand how the code execution path is often hidden, it may be useful to briefly look at general operations of a basic computer system. The brains of the computer system are the central processing unit (CPU) that fetches instructions from memory and executes them. Typically, the CPU only runs one function or method of a program(s) at a time but maintains multiple functions or methods as active by storing a number of variable, temporary results, and other information in registers. Special registers are provided that may be visible to the debugger such as a program counter that contains a memory address for the instruction currently being or next to be fetched and executed and a stack pointer that points to the top of the current stack in memory. The stack contains one frame for each of a set of functions or procedures that has been entered by the CPU but not yet completed and each stack frame holds a collection of information relevant to the corresponding function, such as data copied from registers or other variables local to the function. For example, the CPU runs a first function and when the first function calls a second function the CPU stores the information in the registers in a frame of the stack corresponding to the first function. When the second function calls a third function, the CPU stores information in its registers to another frame of the stack corresponding to the second function. This process is continued during operation of the CPU until the stack has numerous frames with register information for numerous called or entered functions. The core file includes an image of the stack and the debugger can use the stack and can use the stack to try to identify the code execution path.

Unfortunately, the above example of a stack including frames and register information for all called functions is accurate only for programs that have been compiled from source code without or with only minor optimization. A compiler is a program that accepts as input a program text in a certain language and produces as output a program text in another language while preserving the meaning of that language, i.e., translate a program in a source language into a target language. The target language is selected generally to be understandable by the hardware of the computer system and more specifically by the CPU, such as machine language or executable code. Optimizations are attractive in compilers to increase the efficiency of the operating computer system, the speed at which a compiled program can run, and the amount of resources that are required to run the compiled program.

For example, optimization is usually performed to reduce the amount of memory required for stacks and the number of stack operations performed by the CPU. Unfortunately, this results in a generated object code or compiled program that is faster but that is also much more difficult to debug because the execution path for the code can not always be determined by looking at the program stack. For example, compilers may perform tail call optimization in which one or more intermediate functions call another function as their final action and thus, no longer need their stack frame. That frame is discarded for re-use by the function it calls. In this case, a CPU may enter or call a number of functions (such as 1 to 10 or more) but only store a subset of the function registers in frames in the stack (such as a frame for Function 1, a frame for Function 6, and a frame for Function 10). A system analyst looking at the stack would at first glance believe that Function 1 calls Function 6 that in turn calls Function 10, but in practice these functions may never call each other directly but instead one or more intermediary functions are called or entered by the CPU without the CPU retaining information from the registers in the program stack. Code execution path tracking is very useful in determining how a source function got to a destination function and in understanding what data was passed to the destination function through intermediate functions. Some debugging programs and techniques are in use that allow a debugger to step through a program to debug the program but typically such step-by-step debugging is not practical or useful as a debugger will be working with a post-panic or post-fault core file trying to identify the cause of the crash or problem. Further, operating on a live or active system is often not useful in identifying the problem or cause of the crash as it is nearly impossible to duplicate or recreate the exact operating conditions or environment that were occurring when the crash took place and it is often cost prohibitive or too intrusive to debug an active computer system at a customer location.

Hence, there remains a need for an improved method and system for use in determining a code execution path based on a core file created in a crash dump or in an active system. Preferably, such a method and system would allow a debugger to trace function execution in a call stack for a particular program such as a kernel or a user program or application.

### SUMMARY OF THE INVENTION

The present invention addresses the above problems by providing a mechanism and method for determining code execution paths based on stack information plus programming code provided in a core file or for similar information obtained for a live system. Generally, the method involves processing stack information to determine flow or execution gaps between functions identified in sequential or adjacent frames in the stack (e.g., pairs of functions in the stack that do not directly call each other and for which it is not readily apparent the call path or chain between the pair of functions). The method continues with determining one or more direct call chains or paths between the pair of functions. This tracking process or path determination can be performed by determining every direct path between the two functions (in this document often labeled source and destination functions) by scanning the source function for functions it calls and then repeatedly scanning the called functions until a branch reaches the destination function or terminates with a function other than the destination function. In another embodiment of the determination process, the set of paths is determined by identifying call branches from the source function but terminating the processing or following of a call branch whenever a repeat function is found, i.e., a function that was processed or scanned in an earlier branch or in the same branch. In yet another embodiment of the determination process, the result set of potential paths is generated by identifying branches from the source function but only continuing to follow a call branch when intermediate nodes or functions are followed by or associated with a restore function (or other function that acts to discard a frame for that intermediate function in the stack). The resulting set of potential flow or execution paths is typically stored for further processing by a debugger, such as to identify the true flow path among the potential paths, and for reporting to a debugger and/or a requesting client.

### BRIEF DESCRIPTION OF THE DRAWINGS

FIG. 1 illustrates in block diagram form a technical support system according to the present invention including a debugging system utilizing a code execution tracking mechanism for determining execution paths from core files;

FIG. 2 is a simplified illustration of a stack used by a CPU for storing register information for functions of a program;

FIG. 3 is an exemplary tree structure generated or used by the code execution tracking mechanism of FIG. 1 for modeling a program in the core file and determining code execution flow in a gap in a stack, such as the stack of FIG. 2; and

FIG. 4 is a flow chart illustrating code execution path determination or tracking functions performed by a debugger of the present invention such as the debugger with a code execution tracking mechanism shown in FIG. 1.

### DETAILED DESCRIPTION OF THE PREFERRED EMBODIMENTS

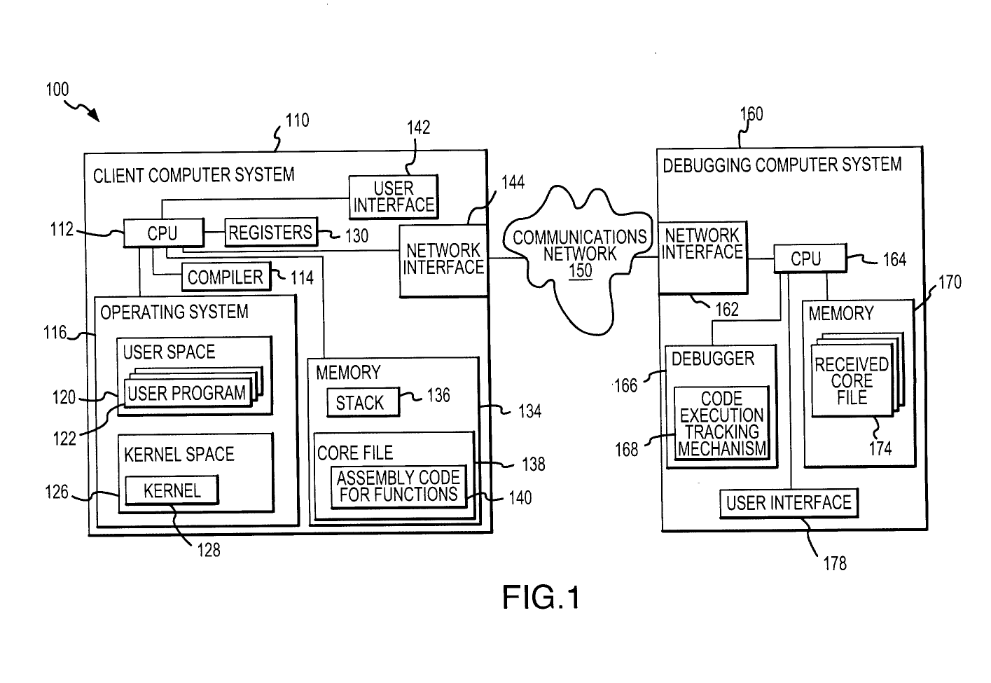

In the following discussion, computer systems and network devices, such as client computer system 110 and debugging computer system 160 of FIG. 1, are described in relation to their function rather than as being limited to particular electronic devices and computer architectures. To practice the invention, the computer and network devices may be any devices useful for providing the described functions and may include well-known data processing and communication devices and systems such as personal, laptop, and notebook computers with processing, memory, and input/output components and server devices configured to maintain and then transmit digital data over a communications network. Data, including client requests and transferred core files and transmissions to and from the debugging computer system, typically is communicated in digital format following standard communication and transfer protocols, such as TCP/IP, HTTP, HTTPS, and the like, but this is not intended as a limitation of the invention. Additionally, the invention is directed generally toward debugging programs and applications including user programs and kernels and is intended to be used for determining code execution paths for a wide variety and number of operating systems and higher level programming languages.

FIG. 1 illustrates an exemplary technical support system 100 incorporating a debugging computer system 160 that is configured according to the invention to assist a user or debugger in determining one or more potential code execution paths from a core file, which may only show an execution path having one or more gaps that without the features of the invention would be difficult to fill. In typical operation of the system 100, a client (such as client computer system 110) transmits a request for assistance in identifying and correcting a problem in operation of their system, such as in response to a system crash or panic. The assistance request includes a copy of the core file or crash dump file for the system or portion of the system (or this file is obtained later) and the debugging computer system 160 acts to debug a program that caused the problem or crash based on the core file and such debugging is facilitated by features of the invention that enable a debugger to determine more accurately the code execution path for the problematic program (such as a user application or the system kernel).

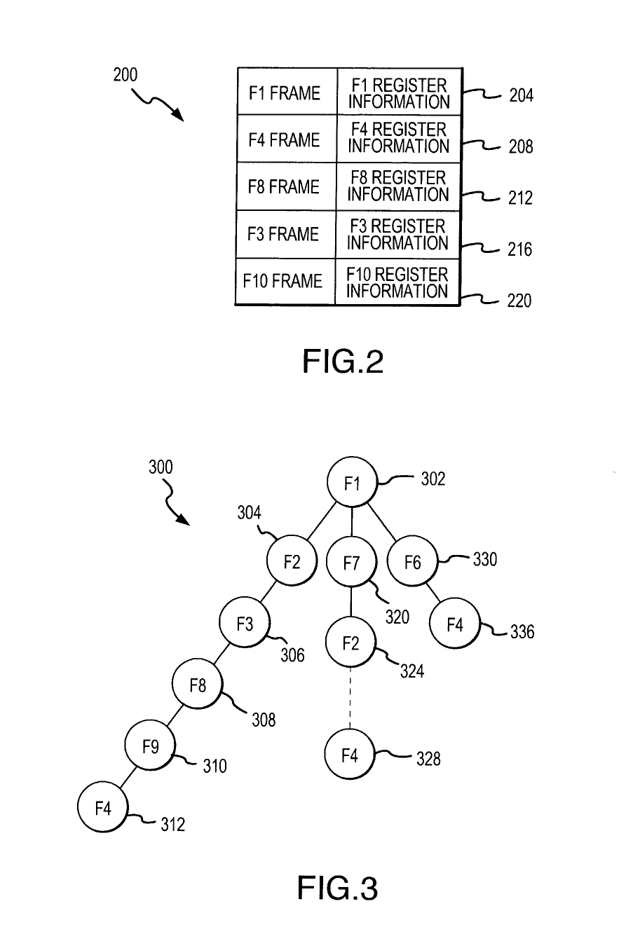

As shown, the system 100 includes a client computer system 110 linked to the debugging computer system 160 via communications network 150 (e.g., the Internet, a LAN, a WAN, and the like) for communicating debugging requests, for transferring core files (or other program information), and for reporting debugging results from the debugging computer system 160 to the client computer system 110. The client computer system 110 may take many forms but generally will include at least one CPU 112 to manage operation of the system 110 including functioning of the operating system 116, storage of data in memory 134, display of data or information to a user via a user interface 142 (such as a GUI or command line interface), and communications with other devices via network 150 via network interface 144. A compiler 114 is provided for translating source code into a target code executable by the operating system 116, e.g., generating executable assembly code such as user programs 120 and kernel 128. The compiler 114 may take many forms and be nearly any compiler, standard or relatively unique, that is configured to optimize source code used to form the kernel 128 and/or user programs 122, which results in gaps in code paths in the stack 136 (as is explained in detail below with reference to FIG. 2).

The operating system 116 may also take many forms such as Solaris, UNIX, PICK, MS-DOS, LINUX, and the like and generally is a software program that manages the basic operations of the computer system 110. The operating system 116 is shown divided into a user space 120 which is accessible by users and contains user programs and into a kernel space 126 that is generally not accessible by users and contains the kernel 128. The kernel 128 is a portion or level of the operating system 116 that is always running when the operating system 116 is running and contains system-level commands or all the functions hidden from the user including device drivers, memory management routines, the scheduler, and system calls.

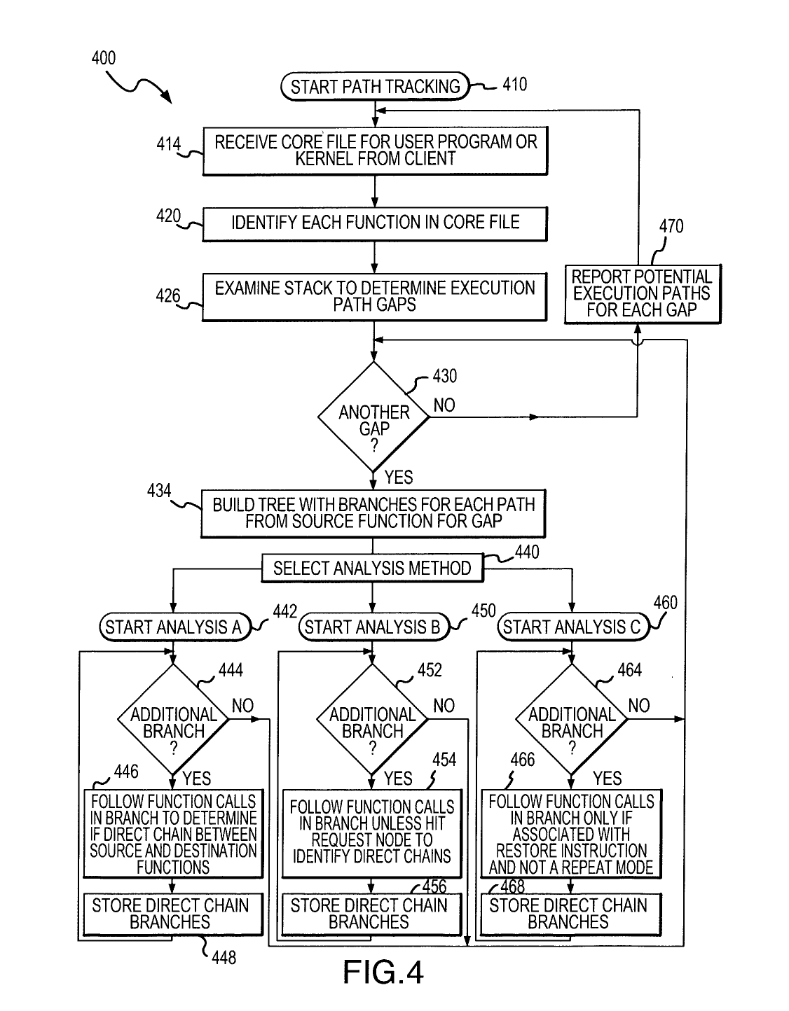

During operating of the CPU 112 and the operating system 116, a user program 122 or the kernel 128 may be running and the CPU 112 operates to temporarily store information for a current function for the user program 122 or kernel 128 in the registers 130 (e.g., variables, instructions being executed, storage addresses, data being retrieved from or sent to storage, a pointer to the current stack 136, and the like). When one function calls another function for the user program 122 or kernel 128, the CPU 112 acts to move the function information in the registers 130 to a frame in the stack 136 for the program 122 or kernel 128 in memory 134 (unless associated with a restore or similar instruction as will be explained with reference to FIGS. 3 and 4). In some cases, the generated (i.e., optimized) code of the user program 122 or kernel 128 is configured such that the CPU 112 does not retain or keep the information in the stack 136 for all functions as one function calls another, resulting in some functions' data being lost. In response to a user instruction or upon a crash of system 110, the CPU 112 acts to generate a core file 138 which is a core image providing a state of the computer system 110 at the time of the core dump and includes a state of the stack 136 for the program running at the time of the crash or core dump and includes assembly code for all the functions in the user program 122 or kernel 128. During operation, an operator of the system 110 may transmit a request for assistance (e.g., debugging help) over the network 150 to the debugging computer system 160. A copy of the core file 138 is transmitted with the request or separately to the debugging computer system 160 via communications network 150 or otherwise (such as on a disk or other portable memory device).

The debugging computer system 160 includes a network interface 162 communicatively linking the system 160 to the communications network 150 and communicating with the client computer system 110. The debugging computer system 160 includes a CPU 164 managing operations of the system 160 including the debugger 166, the user interface 178 (such as a command line interface, GUI, and the like), and the memory 170. Received core files 174 are stored by the CPU 164 in memory 170 for later processing by debugger 166. As with the client computer system 110, the debugging computer system 160 and its hardware and software components may take numerous forms and configurations to practice the invention.

The debugger 166 is generally a software and/or hardware mechanism that functions to process the received core file 174 at the instruction of a user via user interface 178 and/or automatically to determine one or more possible code execution paths for flow gaps in stack 136 as indicated in the received core files 174. In this regard, a code execution tracking mechanism 168 is provided to process the received core files 174 and interact with an operator (i.e., a debugger) of the user interface 178 to identify potential flow paths for executed code (such as user programs 122 or kernel 128) that may have caused a panic or crash in the client computer system 110. The functioning of the code execution tracking mechanism 168 is described in detail with reference to FIGS. 3 and 4.

FIG. 2 illustrates an exemplary stack 200 (such as stack 136) that may be represented by information in the core file 138 (or received core file 174). The stack 200 is a greatly simplified version of a stack as many stacks will have many more frames with larger gaps between functions. As shown, the stack 200 has five frames 204, 208, 212, 216, 220 containing register information (stored from registers 130 by CPU 112) for five functions (i.e., functions F1, F4, F8, F3, and F10). Note, that many stacks are written bottom up (or the opposite of that shown in FIG. 2) such that if F1 calls F2 which calls F3 a debugger 166 would show F3, F2, and then F1 because F3 is executing and when F3 is done the top of the “stack” of functions would be removed leaving F2 at the top. Referring again to the example of FIG. 2, as can be seen, the flow path appears to be function F1 calling function F4 calling function F8 and so on. However, in practice, function F1 may not call function F4 directly nor function F4 call function F8 directly. If this is the case, a flow gap or code execution path gap can be said to exist between these pairs of functions even though the functions have adjacent frame positions in the stack 200. Without knowledge of the true chain or path between these pairs of functions, debugging the program corresponding to the core file containing the stack 200 may be very difficult.

FIG. 3 illustrates a tree structure or tree model 300 of several flow paths (or branches) that may exist for the flow gap between function F1 and function F4. The stack 200 can be thought of as being built from the top (although many stacks are built from the bottom) and function F1 in this example can be labeled the source function and function F4 (which comes later in the stack 200) can be labeled the destination function. As shown in tree 300, one branch or possible flow path leads from a node 302 representing function F1 to a node 304 representing function F2 to similar nodes 306, 308, 310, 312 representing functions F3, F8, F9, and F4, respectively. As can be seen, function F1 does not call function F4 directly and it would be difficult to guess the order of number of functions between function F1 and function F4. Another branch extends from node 302 representing function F1 to nodes 320, 324, and 328 representing functions F7, F2, and F4 (with the functions between F2 and F4 being left off but shown in the first branch discussed above). In this branch, it can be seen that functions are often not called in any type of sequential order which makes determining execution flow paths more difficult. Yet another branch is shown from node 302 representing function F1 extending to nodes 330 and 336 representing functions F6 and F4, respectively. While this tree structure 300 is greatly simplified compared with typical tree structures created according to the invention by the code execution tracking mechanism 168, the tree structure 300 is useful for explaining how code execution flow or path determinations are performed according to the invention.

In this regard, FIG. 4 illustrates a code execution path tracking process 400 performed by the mechanism 168 during operation of the system 100. The process 400 starts at 410 typically with establishing communication links between the debugging computer system 160 and the client computer system 110 (or, more typically, with numerous client systems and devices supported by debugging computer system 160). The startup at 410 may further include initiating the code execution tracking mechanism 168 by a debugger or other user for running on the computer system 160. At 414, the process 400 continues with the receipt of a copy of core file or a crash dump file (such as a copy of core file 138) or any correct copy of system code (such as from a copy showing the active or live system code) from the client computer system 110. The received core file (or, again, other copy of code) includes information on the configuration of the stack 136 and assembly code for functions of program (such as a user program 122 or the kernel 128). The core file may be from an active system 110 or may have been created after a panic or system crash. The received file are stored as a received core file 174 in memory 170. The debugging computer system 160 may receive and store a plurality of core files 174 from the client computer system 110 or other clients and systems (not shown) over the network 150 or by other digital data delivery methods.

At 420, the tracking mechanism 168 retrieves the received core file 174 from memory 170 and processes the file 174 to identify each function for which assembly code is included in the core file 174. For example, core files 174 for the kernel 128 typically will include assembly code for all functions of the kernel 128. At 426, the tracking mechanism 168 processes the information in the core file 174 for the stack 136 to determine each flow gap or execution path gap or more preferably a limited number of the total gaps useful for analysis of a particular problem (such as 1 gap, 2 gaps, or more) to limit required processing. Referring to FIG. 2, flow gaps occur when functions in adjacent or sequential pairs of the frames 204, 208, 212, 216, 220 do not directly call each other. For example, flow gaps may exist between frames 204 and 208 if function F1 does not directly call function F4 from the current location within F1, between frames 208 and 212 if function F4 does not call function F8, between frames 212 and 216 if function F8 does not call function F3, and between frames 216 and 220 if function F3 does not call function F10 (again, these functions may call each other directly but since the exact instruction within a function is stored at a particular location these functions are not directly calling each other). Hence, at 426, the tracking mechanism 168 examines the functions in the frames 204, 208, 212, 216, and 220 in stack 200 (or in stack 136) to determine if flow gaps indicated by breaks in the call chain of sequential or adjacent frames.

At 430, the tracking mechanism 168 looks for another path gap to process (i.e., determines whether all of the gaps identified in step 426 have been analyzed for a direct call chain between a source function and a destination function or all gaps in an identified subset of all gaps useful for analyzing a particular problem). If another gap remains to be analyzed, the process 400 continues at 434 with forming a model of flow paths from a source function that may potentially provide a direct call chain between the source function of the particular gap and the destination function of the gap. For example, a tree structure, such as structure 300 of FIG. 3, may be built by the tracking mechanism 168 for the flow gap between function F1 and F4 (i.e., between frames 204 and 208 of the stack 200) with function F1 being the source function and function F4 being the destination function for the flow gap. In some embodiments of the tracking mechanism 168 a decision model is not constructed and instead step 434 simply involves identifying functions from step 420 that are called by the source function (in this case function F1). Step 434 typically involves at least identifying first nodes of potential branches in a tree structure (such as structure 300). The first node of potential branches can be determined because the location in a particular function is stored exactly and this should be the functions being called by a particular source function.

The tracking mechanism 168 in some embodiments is configured for analyzing the core file 174 using different techniques which can be thought of as differing levels of optimization. For example, as shown in FIG. 4, three different analysis methods can be provided by the tracking mechanism 168 and are labeled Methods A, B, and C. Each analysis method provides a set of potential code execution paths between a source function and a destination function with Methods B and C providing optimization techniques that may be optionally employed to obtain a much small set of potential paths that typically will reduce efforts by debuggers in determining the actual flow path from the small set of potential flow paths. At step 440, the analysis method is selected and this may involve providing a prompt to a user on the user interface 178, involve receiving instruction from the user on a command line indicating which analysis method to utilize, or the tracking mechanism 168 may be configured as part of the initiation step 410 to default to a specific level or method of analysis (e.g., a debugger may request the highest level of optimization, i.e., Method C, each time the tracking mechanism 168 is run).

If analysis Method A is selected, the process 400 continues with starting analysis of the stack gap at 442. Method A can be thought of as a brute-force technique in which every direct call chain or direct flow path (such as all 3 branches of the tree 300 in FIG. 3) are identified and included in the resulting set of potential flow paths for the stack gap. At 444, the tracking mechanism 168 determines if there are any branches left to be analyzed, i.e., have all the functions directly called by the source function been analyzed, which as shown in structure 300 for function F1 would be branches beginning with functions F2, F7, and F6. If another branch remains, Method A continues at 446 with examination of each function to identify a direct call chain from the source function to the destination function. For example, with reference to FIG. 3, functions F2, F7, and F6 are examined to identify the functions they call. Each of the called functions, including functions F3, F2, and F4 are analyzed to determine the functions they call and so on until the call chains or branches extending from the source function F1 have been followed to their ends or to the destination function (here function F4). Each direct chain or flow path for the gap between the source and destination functions is stored at 448. Note, the structure 300 is greatly simplified as a typical analysis would include “false” branches and leaves in the structure 300 in which Method A includes examining branches that do not result in a direct call chain or flow path between the source and destination functions (i.e., the terminal function of many branches is a function other than function F4 in the illustrated example). These false branches are not stored at 448 as they are not included in the resulting set of potential flow paths.

At 444, Method A continues with looking for another branch from the source function for analysis. When all branches have been analyzed, the process 400 continues at 430 with the determination of whether additional gaps need to be examined for determination of additional flow paths across stack gaps. Once all gaps in the stack have been filled with sets of potential code execution paths, the process 400 continues at 470 with the reporting of the results of the tracking process 400 for the particular core file. Typically, this will involve displaying the sets of potential code paths for the stack gaps at the user interface 178. The user or debugger can perform additional analysis of the code paths sets to identify the true paths in each gap. The flow path information may also be transferred in part or total before or after the additional track analysis by an operator to the client computer system 110 for display on the user interface 142 (or for printing of hard copies of the information).

If Method B is selected at 440, analysis of the stack flow gap continues at 452 with the determination of whether additional branches remain. Method B differs from Method A in that analysis of a call chain or branch originating from the source function is followed until a terminal node is reached, until the destination function node is reached, or until a function node is reached that has previously been examined. With this in mind, Method B continues at 454 with the following of function call branches from the source function (node 302 representing function F1 in structure 300). In 454, if a repeat node or node that has already been analyzed is located in a branch, the branch analysis is terminated in 454 and the branch or flow path is not searched further, since that portion of the tree has already been descended. Instead, the new path to that subtree is merged with the existing potential flow path data.

For example, when Method B is used to analyze the structure 300 of FIG. 3, the tracking mechanism 168 processes through the branch beginning with node 304 representing function F2 and continues on to node 312 representing F4. At this point, the direct chain from the source to the destination function is stored in memory 170 and at 452, it is determined that another branch remains to be analyzed. At 454, the tracking mechanism 168 acts to begin analysis of the branch beginning with node 320 representing function F7 and continues until node 324 is reached that represents function F2. Because function F2 has already been examined (as node 304) in an earlier examined call chain or flow path, the tracking mechanism 168 stops processing of this branch in the structure 300 and at 456, the branch starting with node 320 representing function F7 is merged with the existing flow path data for the current stack gap. At 456, terminal nodes not matching the destination function are eliminated from inclusion in the set of potential flow paths. In this manner, Method B increases the efficiency of the initial flow path analysis for each stack gap and also significantly reduces the number of results included in the set of potential flow paths stored in memory 170, which reduces the level of effort required by a debugger or operator of the debugger 166 in identifying the true code execution path for the stack gap among the set of potential flow paths.

If Method C is chosen or set at 440, the analysis 400 continues at 460 with this alternative code execution path analysis technique that examines instructions around or corresponding to each function for instructions that clears or discards a stack frame for that particular function. Discarding of a stack frame for a function is the action taken by the CPU 112 which results in a flow gap in the stack 136. One example of such an instruction is the “restore” instruction or similar instructions used by operating systems to clear or discard a stack frame. The instruction may follow the function call or proceed the function call depending on the system architecture, but is in some way tied or linked to a particular frame in the stack for a particular function. The use of such a command typically results in the CPU 112 discarding the current function's stack frame as memory to be used by the function it is calling for its stack frame. For example, referring to FIG. 2, the flow gap between frames 204 and 208 storing information for functions F1 and F4 may be caused by the inclusion of a restore or similar instruction in the underlying user program or kernel near the intermediate or “gap” functions between the source function (function F1) and the destination function (function F4). As further explanation, a typical function operates basically to: save my stack frame; perform local processing; restore/release my stack frame; and then exits. The functions searched for in Method C, in contrast, operate to: save my stack frame; perform local processing; call another function and restore/release my stack frame; and the exit, which prevents really reaching the exit as the stack frame of the function has been discarded.

To take advantage of the use of the restore instruction, Method C at 464 looks for a next branch to analyze and at 466, follows function calls (or nodes) in a branch of structure 300 only if the function call has a restore or similar stack-frame-releasing instruction associated with the function call. More generally, Method C optimization works for all mechanisms that are used to release a stack in a flow path and is not limited to the restore instruction (e.g., any mechanism in which although flow is F1 to F2 to F3, the stack frame for F2 is not retained). If a direct chain is identified, at 468, the tracking mechanism 168 stores the flow path as a potential code execution path between the source and the destination functions and looks for additional branches to process at 464. Once all branches have been saved or discarded at 468, the process 400 continues at 430 with the determination of whether additional gaps in the stack 136 exist that need to be processed. If not, the results of the flow path analysis of Method C are reported to the debugger and/or client (as discussed above) at 470. The use of the optimization technique in Method C significantly reduces the number of potential flow paths included in the set of potential flow paths for a particular stack gap and often results in the set only including one or two potential code execution paths, thereby improving the efficiency of debugging efforts by a user of the debugging computer system 160. This reduction is created because many branches are of a structure such as structure 300 can be eliminated once it is determined that frames are provided in the stack 136 for nodes in the branch which indicates that the node and the branch do not represent a hidden flow path.

Although the invention has been described and illustrated with a certain degree of particularity, it is understood that the present disclosure has been made only by way of example, and that numerous changes in the combination and arrangement of parts can be resorted to by those skilled in the art without departing from the spirit and scope of the invention, as hereinafter claimed. For example, the debugging system 160 does not, of course, need to be provided as a separate system or device and its components and their functions may be provided as part of the client computer system 110.

We claim:

1. A computer-based method for determining a code execution path, comprising:
retrieving a file including assembly code for functions of a program and data for a stack maintained by a processor running the program, wherein the stack includes frames corresponding to at least some of the functions;
identifying an execution path gap between a first one and a second one of the functions corresponding to a first one and second one of the stack frames; and
determining code execution paths for the gap between the first and second functions.

2. The method of claim 1, wherein the determining includes following function calls from the first to the second function to identify direct call chains and storing the direct call chains as the code execution paths.

3. The method of claim 1, wherein the determining includes identifying branches from the first function beginning with a call to another one of the functions, for each of the identified branches following function calls from the first function to identify direct call chains between the first and the second functions, and storing each of the direct chain branch.

4. The method of claim 3, wherein the following is halted for one of the identified branches upon reaching a function that has been processed previously in the function calls following.

5. The method of claim 1, wherein the determining includes following each function call branch from the first function to the second function by examining each of the functions in the file called until the second function is reached or a terminal leaf in the function call branch is reached.

6. The method of claim 5, wherein the following of a function call branch is continued only when an examined one of the functions is associated with a restore instruction discarding a frame in the stack for the examined one of the functions.

7. The method of claim 6, storing each of the examined function call branch for which the second function is reached during the examining in a set of potential flow paths for the gap in the stack.

8. The method of claim 1, wherein the file is a core file and the program is a kernel for an operating system run by the processor.

9. The method of claim 1, further including repeating the gap identifying and code execution paths determining for additional ones of the functions in adjacent ones of the frames of the stack.

10. The method of claim 1, further including receiving the file from a client computer system and generating a report including at least a portion of the code execution paths.

11. A method for debugging code, comprising:
receiving a core file;
identifying a gap in a code execution path between a source function and a destination function in the core file;
determining call branches from the source function by scanning the source function for all functions called by the source function; and
identifying a set of potential flow paths for the gap by following function calls in each of the call branches that are associated with a restore instruction until a last function in a branch is reached not matching the destination function or the destination function is reached.

12. The method of claim 11, wherein the core file includes assembly code for functions of a kernel of an operating system.

13. The method of claim 11, further including storing the set of potential flow paths and reporting the set of potential flow paths.

14. A computer system for use in debugging code, comprising:
a network interface communicating with a communications network and receiving debugging requests including a core file;
a data storage device for storing the core file; and
a debugger including a mechanism adapted to determine code execution paths between functions in a stack defined in the core file.

15. The system of claim 14, wherein the debugger mechanism determines the code execution paths by identifying execution path gaps between pairs of the functions and for each pair scanning a source one of the pair for called functions and called functions for additional called functions until a destination one of the pair is reached or a terminal function is reached that differs from the destination one.

16. The system of claim 14, wherein the debugger mechanism determines the code execution paths by identifying execution path gaps between pairs of the functions and for each of the pairs having a gap identifying call branches for a source one of the pair and following calls in the branch until a function is reached that has previously been reached in another branch, until a destination one of the pair is reached, or a terminal function is reached differing from the destination one.

17. The system of claim 14, wherein the debugger mechanism determines the code execution paths by identifying execution path gaps between pairs of the functions and for each of the pairs having a gap identifying call branches for a source one of the pair and following calls in the branch for functions included in the core file associated with a restore instruction for the stack until a destination one of the pair is reached or a terminal function is reached differing from the destination one.
